(19) United States
(12) Patent Application Publication
(10) Pub. No.: US 2025/0171151 A1
(43) Pub. Date: May 29, 2025

(54) Lift System for Aircraft

(71) Applicant: The Boeing Company, Arlington, VA (US)

(72) Inventors: Sergey D. Barmichev, Everett, WA (US); Aaron J. Kutzmann, Arlington, VA (US); Ian Nordhoy, Seattle, WA (US)

(21) Appl. No.: 18/523,137

(22) Filed: Nov. 29, 2023

(51) Int. Cl. B64D 11/00; B64D 11/04

(52) U.S. Cl. CPC B64D 11/0007; B64D 11/04

(57) ABSTRACT

A lift system includes first, second, and third galley carts, a floor deck, and a frame that defines first, second, and third storage zones. The second storage zone is above the first storage zone and the third storage zone is forward or aft of the first storage zone. Bottom ends of the first storage zone and the third storage zone are aligned with the floor deck, and top ends of the first storage zone and the third storage zone are aligned with a bottom end of the second storage zone. The lift system also includes a lift configured to move the second galley cart from the first storage zone to the second storage zone. The first storage zone is configured to receive the first galley cart and the third storage zone is configured to receive the third galley cart while the second galley cart is within the second storage zone.

### FIELD

The present disclosure generally relates to a lift system, and more specifically to a lift system for aircraft galley carts.

### BACKGROUND

Some commercial aircraft include galleys for storing and preparing food for passengers. Galleys generally include storage spaces for galley carts, which in turn contain food trays, beverages, and the like. For long flights during which two or three meals are served, large galleys are needed to accommodate the galley carts needed to store the large amount of food and waste. These large galleys occupy space that could otherwise be used for passenger seats. This reduces the amount of revenue for the airline. As such, a need exists for a commercial aircraft galley system in which galley carts may be efficiently stowed and accessed.

### SUMMARY

A first example is a lift system for an aircraft, the lift system comprising: a first galley cart; a second galley cart; a third galley cart; a floor deck; a frame that defines a first storage zone, a second storage zone, and a third storage zone, wherein the second storage zone is above the first storage zone and the third storage zone is forward or aft of the first storage zone, wherein a bottom end of the first storage zone and a bottom end of the third storage zone are aligned with the floor deck, and a top end of the first storage zone and a top end of the third storage zone are aligned with a bottom end of the second storage zone; and a lift configured to move the second galley cart from the first storage zone to the second storage zone, wherein the first storage zone is configured to receive the first galley cart and the third storage zone is configured to receive the third galley cart while the second galley cart is within the second storage zone.

A second example is an aircraft comprising a lift system, the lift system comprising: a first galley cart; a second galley cart; a third galley cart; a floor deck; a frame that defines a first storage zone, a second storage zone, and a third storage zone, wherein the second storage zone is above the first storage zone and the third storage zone is forward or aft of the first storage zone, wherein a bottom end of the first storage zone and a bottom end of the third storage zone are aligned with the floor deck, and a top end of the first storage zone and a top end of the third storage zone are aligned with a bottom end of the second storage zone; and a lift configured to move the second galley cart from the first storage zone to the second storage zone, wherein the first storage zone is configured to receive the first galley cart in a direction that is parallel to a longitudinal axis of the aircraft and the third storage zone is configured to receive the third galley cart in the direction while the second galley cart is within the second storage zone.

A third example is a method of loading the lift system of the first and second examples, the method comprising: moving the second galley cart into the first storage zone; moving, via the lift, the second galley cart into the second storage zone; moving the first galley cart into the first storage zone; and moving the third galley cart into the third storage zone.

A fourth example is a method of loading the lift system of the first and second examples, the method comprising: moving the third galley cart into the third storage zone; moving the second galley cart into the first storage zone; moving, via the lift, the second galley cart from the first storage zone into the second storage zone; and moving the first galley cart into the first storage zone.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The features, functions, and advantages that have been discussed can be achieved independently in various examples or may be combined in yet other examples further details of which can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a perspective view of an aircraft, according to an example.

FIG. 2 is a downward cross-sectional view of an aircraft, according to an example.

FIG. 3 is a schematic diagram of a lift system, according to an example.

FIG. 4 is a schematic diagram of a lift system, according to an example.

FIG. 5 is a schematic diagram of a lift system, according to an example.

FIG. 6 is a schematic diagram of a loading process of a lift system, according to an example.

FIG. 7 is a schematic diagram of a lift system, according to an example.

FIG. 8 is a schematic diagram of a lift system, according to an example.

FIG. 9 is a block diagram of a method, according to an example.

FIG. 10 is a block diagram of a method, according to an example.

### DETAILED DESCRIPTION

As noted above, a need exists for an aircraft galley system in which galley carts are efficiently stowed and accessed to allow for additional passenger seating. Examples herein include such a lift system for an aircraft and methods for loading the lift system. Such examples can be particularly useful for a single-aisle narrow body passenger aircraft.

The lift system includes a first galley cart, a second galley cart, a third galley cart, a floor deck, and a frame that defines a first storage zone, a second storage zone, and a third storage zone. The second storage zone is above the first storage zone and the third storage zone is forward or aft of the first storage zone. A bottom end of the first storage zone and a bottom end of the third storage zone are aligned with the floor deck, and a top end of the first storage zone and a top end of the third storage zone are aligned with a bottom end of the second storage zone. The lift system also includes a lift configured to move the second galley cart from the first storage zone to the second storage zone. The first storage zone is configured to receive the first galley cart and the third storage zone is configured to receive the third galley cart while the second galley cart is within the second storage zone. In various examples, the third galley cart is larger or smaller than the first galley cart and the second galley cart.

Thus, two galley carts can be stored within the frame on the floor deck and another galley cart can be stored within the frame above the floor deck. Multiple sets of three galley carts can be arranged in a row as needed. For example, multiple storage zones each including two levels of cart storage for three galley carts can be arranged side-by-side from starboard to port or forward to aft. Storing carts above the floor deck increases space on the floor deck that can be used for additional passenger seating.

Disclosed examples will now be described more fully hereinafter with reference to the accompanying Drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

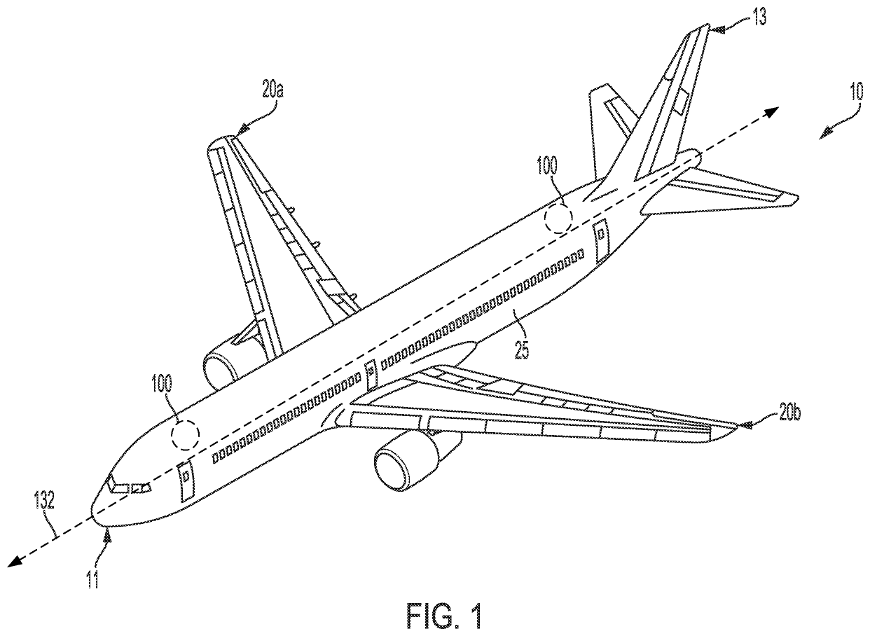

FIG. 1 is a perspective view of an aircraft 10 that includes a nose 11, a wing 20a, a wing 20b, a fuselage 25, a tail 13, and one or more lift systems 100. The aircraft 10 includes many areas arranged for storage of items during flight. In one example, the fuselage 25 includes storage underneath a passenger compartment for storing luggage and other items or supplies. In another example, the passenger compartment in the fuselage 25 includes overhead bins and under seat areas for storing further items.

The aircraft 10 is shown as a commercial airliner, but other examples are possible. In FIG. 1, the lift systems 100 are located near a forward end of the aircraft 10 (e.g., within a galley area) and near an aft end of the aircraft 10 (e.g., within a galley area), however this is not required. The aircraft 10 has a longitudinal axis 132 that spans forward to aft.

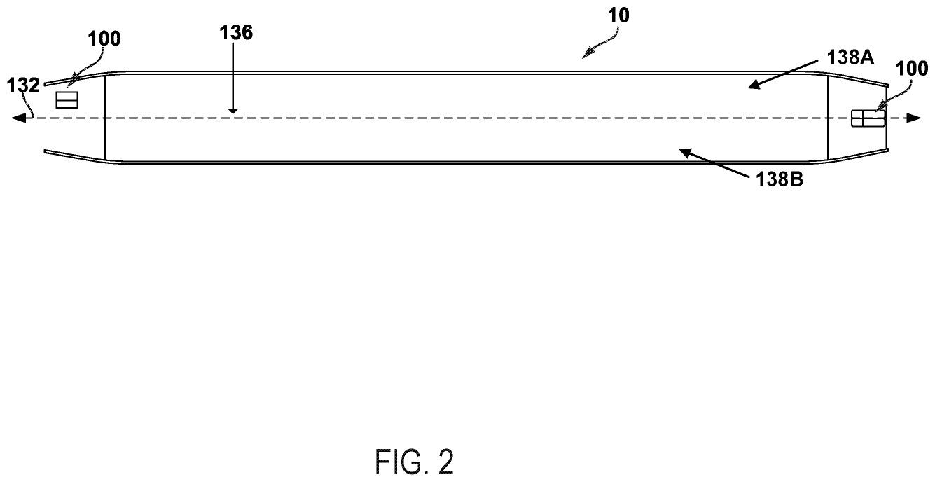

FIG. 2 is a downward cross-sectional view of the aircraft 10. As shown, the aircraft 10 has a single aisle, an aisle 136 that is generally parallel to or collinear with the longitudinal axis 132. The aisle 136 separates two sections of passenger seating. That is, the aisle 136 separates a section 138A of passenger seating on a starboard side of the aircraft 10 from a section 138B of passenger seating on a port side of the aircraft 10. FIG. 2 shows approximate locations of lift systems 100 at forward and aft ends of the aircraft 10, but other examples are possible.

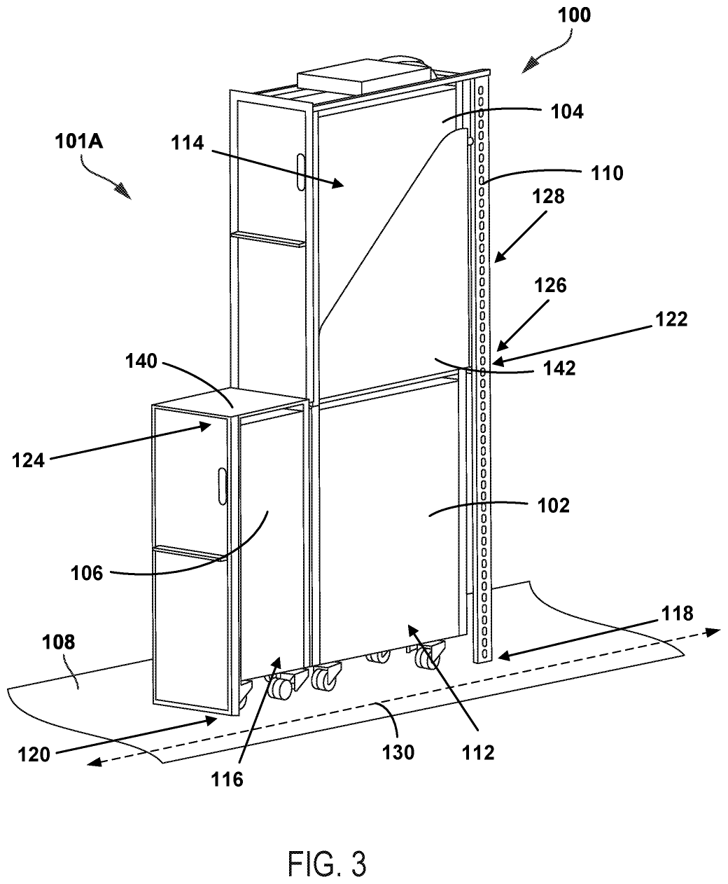

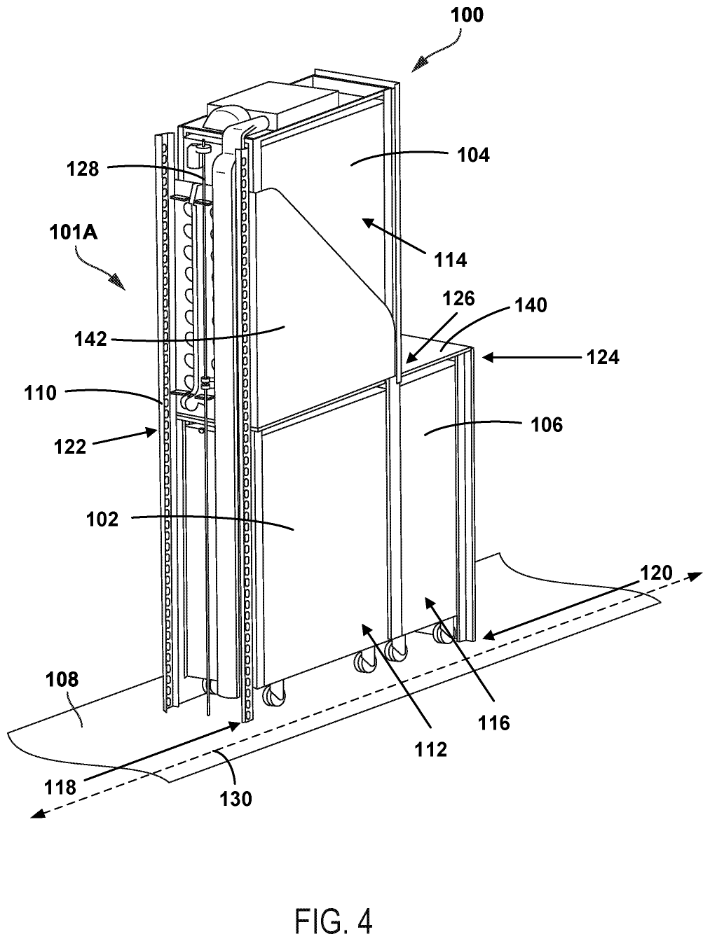

FIG. 3 is a perspective view of a front end of the lift system 100, which can also be referred to as a galley monument. The lift system 100 includes a galley cart 102, a galley cart 104, a galley cart 106, and a floor deck 108. In FIGS. 3-8, some walls of the lift system 100 are omitted for the purpose of clarity. The lift system 100 further includes a frame 110 that defines a storage zone 112, a storage zone 114, and a storage zone 116. The storage zone 114 is above the storage zone 112 and the storage zone 116 is forward or aft of the storage zone 112. A bottom end 118 of the storage zone 112 and a bottom end 120 of the storage zone 116 are (e.g., vertically) aligned with the floor deck 108. A top end 122 of the storage zone 112 and a top end 124 of the storage zone 116 are (e.g., vertically) aligned with a bottom end 126 of the storage zone 114. The lift system 100 also includes a lift 128 configured to move the galley cart 104 from the storage zone 112 to the storage zone 114. The lift 128 is shown in more detail in FIG. 4. The storage zone 112 is configured to receive the galley cart 102 and the storage zone 116 is configured to receive the galley cart 106 while the galley cart 104 is within the storage zone 114.

In some examples not shown in FIG. 3, the galley cart 102, the galley cart 104, and the galley cart 106 are all substantially the same size or exactly the same size. In other examples not shown in FIG. 3, the galley cart 102, the galley cart 104, and the galley cart 106 all have different sizes. The galley cart 102, the galley cart 104, and the galley cart 106 are each storage units (e.g., on wheels) that are configured to store food, beverages, and/or waste on the aircraft 10. The galley cart 102, the galley cart 104, and the galley cart 106 can be collectively referred to as a set 101A of galley carts.

The floor deck 108 is generally a floor surface that is configured to support passengers and seats during flight. The floor deck 108 is typically supported by floor beams.

The frame 110 can be constructed of angle iron (e.g., metal) and fasteners, but other examples are possible. The frame 110 can also be referred to as lift rails and have channel profile features. As shown, the frame 110 forms a countertop workstation 140 above the storage zone 116. The lift system 100 can include doors that, when closed, conceal the galley carts within the frame 110.

In the example of FIG. 3, the galley cart 102 and the galley cart 104 are the same size, whereas the galley cart 106 is smaller (e.g., in the forward/aft direction 130) than the galley cart 102 and the galley cart 104. For example, the galley cart 102 and the galley cart 104 each have approximate dimensions of 32 inches in the forward/aft direction 130, 12 inches in the starboard/port direction, and 40.5 inches in the vertical direction. The galley cart 106 has approximate dimensions of 16 inches in the forward/aft direction 130, 12 inches in the starboard/port direction, and 40.5 inches in the vertical direction.

Additionally, the storage zone 116 is forward or aft of the storage zone 114, depending on the arrangement of the lift system 100. The storage zone 116 is smaller than the storage zone 112 and the storage zone 114 (e.g., in the forward/aft direction 130).

The lift system 100 additionally includes a tray 142 that is configured to house the galley cart 104 in the storage zone 114 while the galley cart 106 is positioned in the storage zone 116 and the galley cart 102 is positioned in the storage zone 112. The tray 142 can include rollers received by the channel profile of the frame 110.

Beginning with an empty lift system 100, loading the lift system 100 can involve moving the galley cart 104 forward or aft through the storage zone 116 into the storage zone 112 and moving, via the lift 128, the galley cart 104 up into the storage zone 114. Loading the lift system 100 can also involve moving the galley cart 102 into the storage zone 112 forward or aft through the storage zone 116 and moving the galley cart 106 forward or aft into the storage zone 116. The lift 128 can be driven via a jack screw turned by a geared electric drive.

FIG. 4 is a perspective view of a rear end of the lift system 100 shown in FIG. 3.

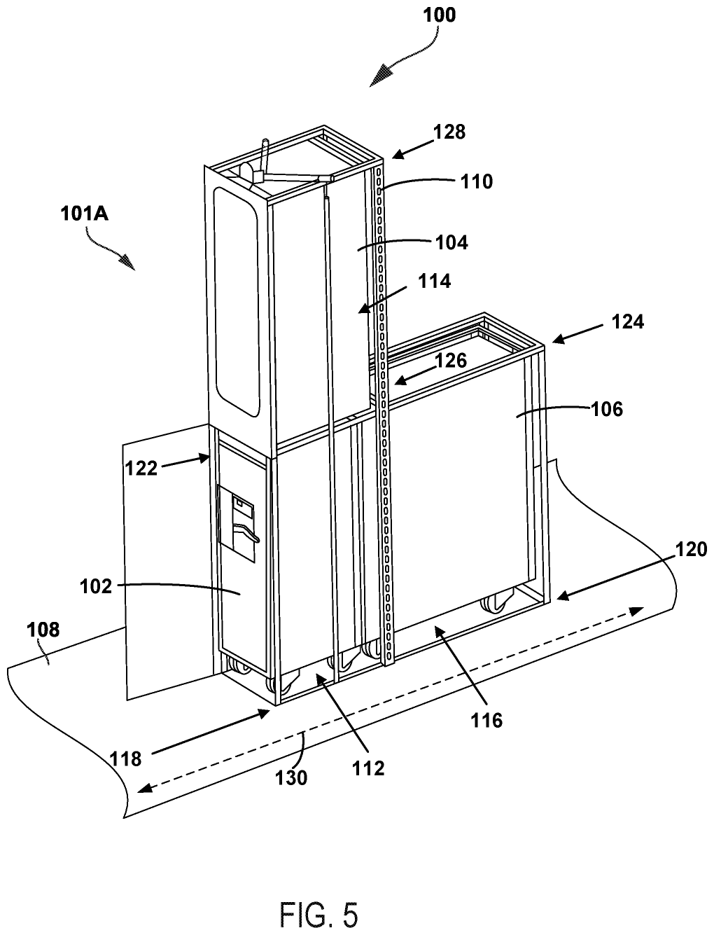

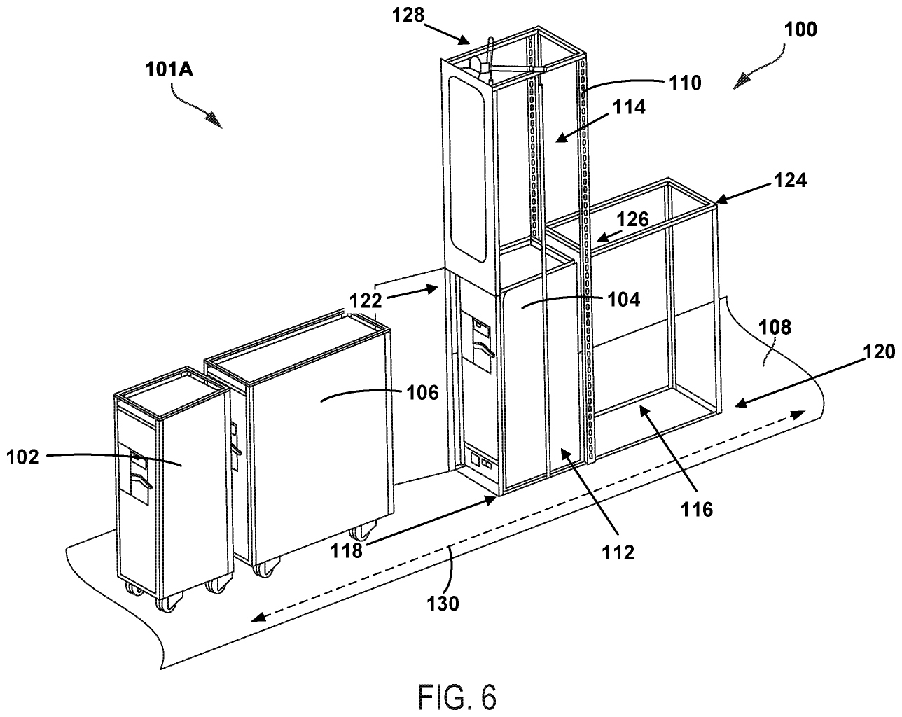

FIG. 5 is a perspective view of a front end of another example lift system 100. Characteristics of components of the lift system 100 described above with reference to FIG. 3 and FIG. 4 will generally be the same as the characteristics of components of the lift system 100 shown in FIG. 5 and FIG. 6 unless noted below.

The lift system 100 includes a galley cart 102, a galley cart 104, a galley cart 106, and a floor deck 108. The lift system 100 further includes a frame 110 that defines a storage zone 112, a storage zone 114, and a storage zone 116. The storage zone 114 is above the storage zone 112 and the storage zone 116 is forward or aft of the storage zone 112. A bottom end 118 of the storage zone 112 and a bottom end 120 of the storage zone 116 are (e.g., vertically) aligned with the floor deck 108. A top end 122 of the storage zone 112 and a top end 124 of the storage zone 116 are (e.g., vertically) aligned with a bottom end 126 of the storage zone 114. The lift system 100 also includes a lift 128 configured to move the galley cart 104 from the storage zone 112 to the storage zone 114. The lift 128 is shown in more detail in FIG. 6. The storage zone 112 is configured to receive the galley cart 102 and the storage zone 116 is configured to receive the galley cart 106 while the galley cart 104 is within the storage zone 114.

In the example of FIG. 5, the galley cart 102 and the galley cart 104 are the same size, whereas the galley cart 106 is larger (e.g., in the forward/aft direction 130) than the galley cart 102 and the galley cart 104. For example, the galley cart 102 and the galley cart 104 each have approximate dimensions of 16 inches in the forward/aft direction 130, 12 inches in the starboard/port direction, and 40.5 inches in the vertical direction. The galley cart 106 has approximate dimensions of 32 inches in the forward/aft direction 130, 12 inches in the starboard/port direction, and 40.5 inches in the vertical direction. As shown, the storage zone 116 is forward or aft of the storage zone 114. The storage zone 116 is larger than the storage zone 112 and the storage zone 114.

FIG. 6 shows a loading process of the lift system 100 shown in FIG. 5.

Beginning with an empty lift system 100, loading the lift system 100 can involve moving the galley cart 106 forward or aft through the storage zone 112 into the storage zone 116 and moving the galley cart 104 forward or aft into the storage zone 112. Loading the lift system 100 additionally involves moving, via the lift 128, the galley cart 104 from the storage zone 112 into the storage zone 114 and moving the galley cart 102 forward or aft into the storage zone 112.

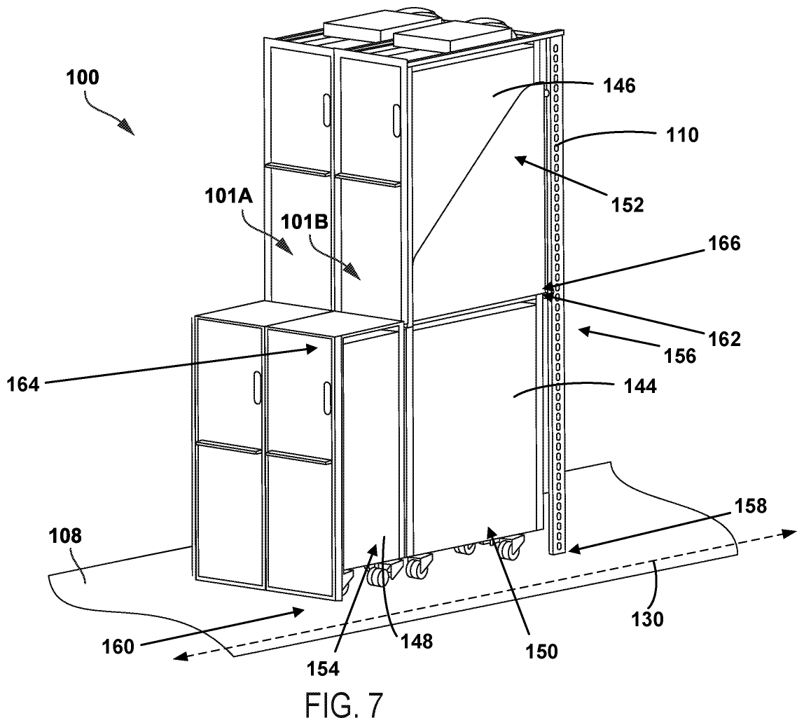

FIG. 7 is a schematic diagram of another example lift system 100. The lift system 100 is similar to the lift system 100 shown in FIG. 3 and FIG. 4. However, the lift system 100 of FIG. 7 includes two sets of galley carts, the set 101A and the set 101B.

The set 101B includes a galley cart 144, a galley cart 146, and a galley cart 148. The frame 110 defines a storage zone 150 that is port or starboard of the storage zone 112, a storage zone 152 that is port or starboard of the storage zone 114, and a storage zone 154 that is port or starboard of the storage zone 116. The lift system 100 further includes a lift 156 configured to move the galley cart 146 from the storage zone 150 to the storage zone 152. The storage zone 150 is configured to receive the galley cart 144 and the storage zone 154 is configured to receive the galley cart 148 while the galley cart 146 is within the storage zone 152.

The storage zone 152 is above the storage zone 150 and the storage zone 154 is forward or aft of the storage zone 150. A bottom end 158 of the storage zone 150 and a bottom end 160 of the storage zone 154 are aligned with the floor deck 108. A top end 162 of the storage zone 150 and a top end 164 of the storage zone 154 are aligned with a bottom end 166 of the storage zone 152.

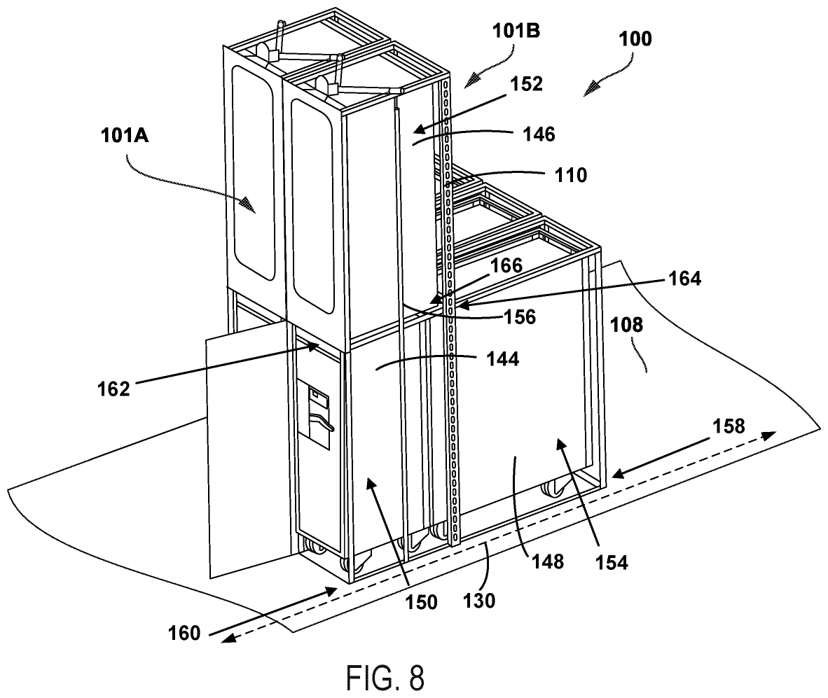

FIG. 8 is a schematic diagram of another example lift system 100. The lift system 100 is similar to the lift system 100 shown in FIG. 5 and FIG. 6. However, the lift system 100 of FIG. 8 includes two sets of galley carts, the set 101A and the set 101B.

The set 101B includes a galley cart 144, a galley cart 146, and a galley cart 148. The frame 110 further defines a storage zone 150 that is port or starboard of the storage zone 112, a storage zone 152 that is port or starboard of the storage zone 114, and a storage zone 154 that is port or starboard of the storage zone 116. The lift system 100 further includes a lift 156 configured to move the galley cart 146 from the storage zone 150 to the storage zone 152. The storage zone 150 is configured to receive the galley cart 144 and the storage zone 154 is configured to receive the galley cart 148 while the galley cart 146 is within the storage zone 152.

The storage zone 152 is above the storage zone 150 and the storage zone 154 is forward or aft of the storage zone 150. A bottom end 158 of the storage zone 154 and a bottom end 160 of the storage zone 150 are aligned with the floor deck 108. A top end 162 of the storage zone 150 and a top end 164 of the storage zone 154 are aligned with a bottom end 166 of the storage zone 152.

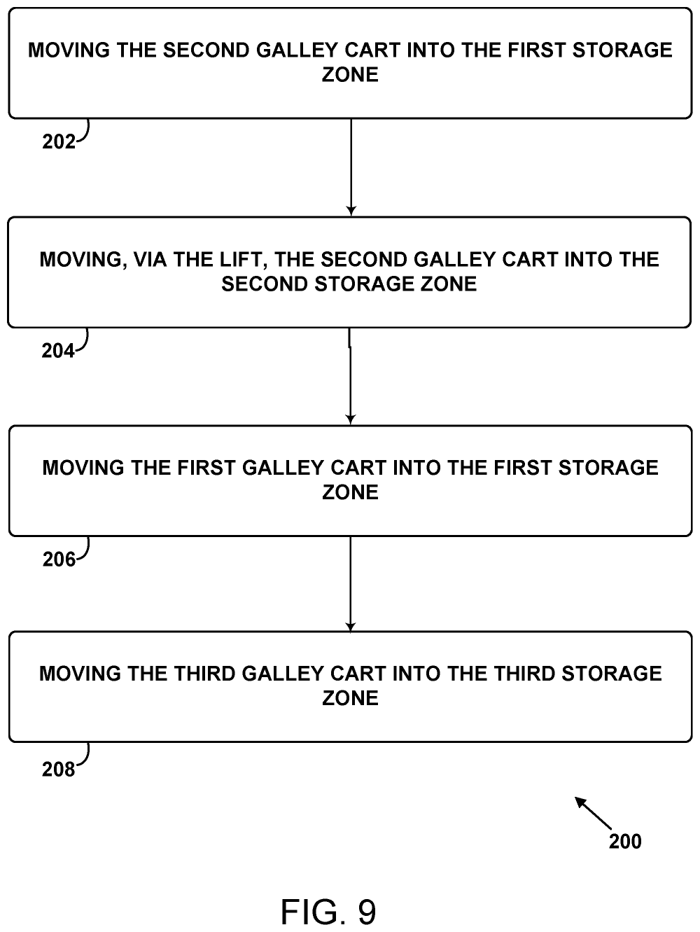

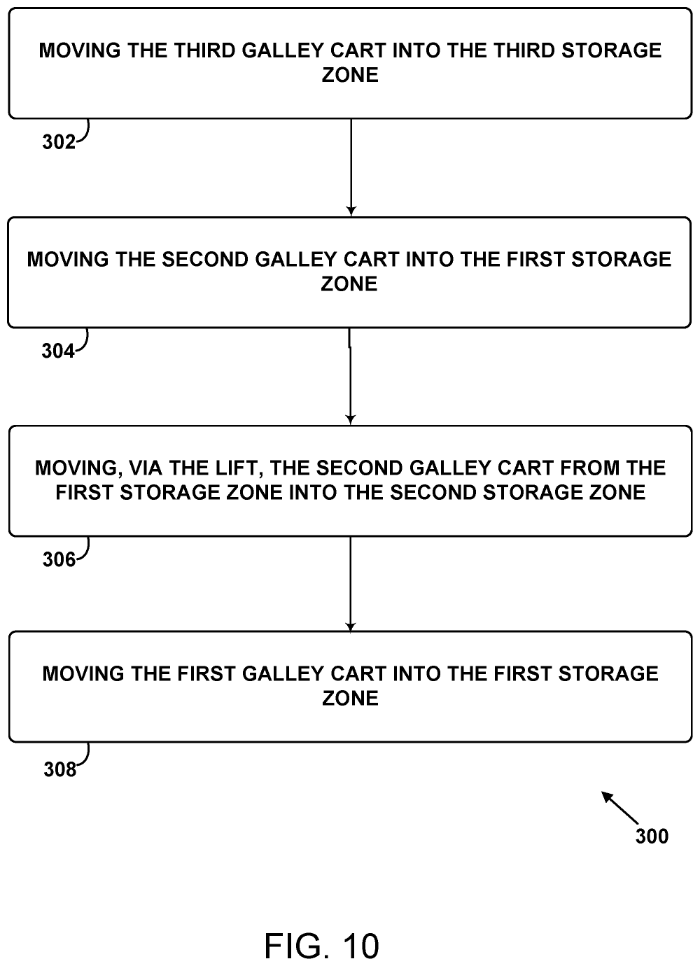

FIG. 9 and FIG. 10 are block diagrams of a method 200 and a method 300 for loading a lift system 100. As shown in FIG. 9 and FIG. 10, the method 200 and the method 300 include one or more operations, functions, or actions as illustrated by blocks 202, 204, 206, 208, 302, 304, 306, and 308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes moving the galley cart 104 into the storage zone 112. Functionality related to block 202 is discussed above with reference to FIGS. 3, 4, and 7.

At block 204, the method 200 includes moving, via the lift 128, the galley cart 104 into the storage zone 114. Functionality related to block 204 is discussed above with reference to FIGS. 3, 4, and 7.

At block 206, the method 200 includes moving the galley cart 102 into the storage zone 112. Functionality related to block 206 is discussed above with reference to FIGS. 3, 4, and 7.

At block 208, the method 200 includes moving the galley cart 106 into the storage zone 116. Functionality related to block 208 is discussed above with reference to FIGS. 3, 4, and 7.

At block 302, the method 300 includes moving the galley cart 106 into the storage zone 116. Functionality related to block 302 is discussed above with reference to FIGS. 5, 6, and 8.

At block 304, the method 300 includes moving the galley cart 104 into the storage zone 112. Functionality related to block 304 is discussed above with reference to FIGS. 5, 6, and 8.

At block 306, the method 300 includes moving, via the lift 128, the galley cart 104 from the storage zone 112 into the storage zone 114. Functionality related to block 306 is discussed above with reference to FIGS. 5, 6, and 8.

At block 308, the method 300 includes moving the galley cart 102 into the storage zone 112. Functionality related to block 308 is discussed above with reference to FIGS. 5, 6, and 8.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A lift system for an aircraft, the lift system comprising:
a first galley cart;
a second galley cart;
a third galley cart;
a floor deck;
a frame that defines a first storage zone, a second storage zone, and a third storage zone, wherein the second storage zone is above the first storage zone and the third storage zone is forward or aft of the first storage zone, wherein a bottom end of the first storage zone and a bottom end of the third storage zone are aligned with the floor deck, and a top end of the first storage zone and a top end of the third storage zone are aligned with a bottom end of the second storage zone; and
a lift configured to move the second galley cart from the first storage zone to the second storage zone,
wherein the first storage zone is configured to receive the first galley cart and the third storage zone is configured to receive the third galley cart while the second galley cart is within the second storage zone.

2. The lift system of claim 1, wherein the third storage zone is forward or aft of the second storage zone.

3. The lift system of claim 1, wherein the third galley cart is smaller than the first galley cart and the second galley cart.

4. The lift system of claim 1, wherein the third galley cart is larger than the first galley cart and the second galley cart.

5. The lift system of claim 1, wherein the third storage zone is smaller than the first storage zone and the second storage zone.

6. The lift system of claim 1, wherein the third storage zone is larger than the first storage zone and the second storage zone.

7. The lift system of claim 1, wherein the lift comprises a tray that is configured to house the second galley cart in the second storage zone while the third galley cart is positioned in the third storage zone and the first galley cart is positioned in the first storage zone.

8. The lift system of claim 1, further comprising:
a fourth galley cart;
a fifth galley cart; and
a sixth galley cart,
wherein the frame further defines a fourth storage zone that is starboard of the first storage zone, a fifth storage zone that is starboard of the second storage zone, and a sixth storage zone that is starboard of the third storage zone, the lift system further comprising:
a second lift configured to move the fifth galley cart from the fourth storage zone to the fifth storage zone,
wherein the fourth storage zone is configured to receive the fourth galley cart and the sixth storage zone is configured to receive the sixth galley cart while the fifth galley cart is within the fifth storage zone.

9. The lift system of claim 8, wherein the fifth storage zone is above the fourth storage zone and the sixth storage zone is forward or aft of the fourth storage zone, wherein a bottom end of the fourth storage zone and a bottom end of the sixth storage zone are aligned with the floor deck, and a top end of the fourth storage zone and a top end of the sixth storage zone are aligned with a bottom end of the fifth storage zone.

10. The lift system of claim 1, wherein the first galley cart and the second galley cart are substantially equal in size.

11. The lift system of claim 1, wherein the third storage zone is narrower than the first storage zone in a forward-aft direction.

12. The lift system of claim 1, wherein the third storage zone is narrower than the second storage zone in a forward-aft direction.

13. The lift system of claim 1, wherein the third storage zone is wider than the first storage zone in a forward-aft direction.

14. The lift system of claim 1, wherein the third storage zone is wider than the second storage zone in a forward-aft direction.

15. An aircraft comprising a lift system, the lift system comprising:
a first galley cart;
a second galley cart;
a third galley cart;
a floor deck;
a frame that defines a first storage zone, a second storage zone, and a third storage zone, wherein the second storage zone is above the first storage zone and the third storage zone is forward or aft of the first storage zone, wherein a bottom end of the first storage zone and a bottom end of the third storage zone are aligned with the floor deck, and a top end of the first storage zone and a top end of the third storage zone are aligned with a bottom end of the second storage zone; and
a lift configured to move the second galley cart from the first storage zone to the second storage zone,
wherein the first storage zone is configured to receive the first galley cart in a direction that is parallel to a longitudinal axis of the aircraft and the third storage zone is configured to receive the third galley cart in the direction while the second galley cart is within the second storage zone.

16. The aircraft of claim 15, wherein the third storage zone is forward or aft of the second storage zone.

17. The aircraft of claim 15, wherein the aircraft is a single-aisle aircraft, and wherein the direction is parallel to a single aisle of the aircraft that separates two sections of passenger seating.

18. The aircraft of claim 15, wherein the frame forms a countertop workstation above the third storage zone.

19. A method of loading the lift system of claim 1, the method comprising:
moving the second galley cart into the first storage zone;
moving, via the lift, the second galley cart into the second storage zone;
moving the first galley cart into the first storage zone; and
moving the third galley cart into the third storage zone.

20. A method of loading the lift system of claim 1, the method comprising:
moving the third galley cart into the third storage zone;
moving the second galley cart into the first storage zone;
moving, via the lift, the second galley cart from the first storage zone into the second storage zone; and
moving the first galley cart into the first storage zone.
